(19) United States
(12) Patent Application Publication
(10) Pub. No.: US 2012/0251900 A1
(43) Pub. Date: Oct. 4, 2012

(54) FUEL CELL SYSTEM

(75) Inventors: Tatsuya SUGAWARA, Saitama (JP); Tomoki KOBAYASHI, Saitama (JP); Motohiro SUZUKI, Saitama (JP); Takuma KANAZAWA, Saitama (JP); Takuya WAKABAYASHI, Saitama (JP); Hayato KAJI, Saitama (JP)

(73) Assignee: HONDA MOTOR CO., LTD., Tokyo (JP)

(21) Appl. No.: 13/433,600

(22) Filed: Mar. 29, 2012

(30) Foreign Application Priority Data
Mar. 31, 2011 (JP) 2011-080177

(51) Int. Cl. H01M 8/06

(52) U.S. Cl. 429/413

(57) ABSTRACT

A fuel cell system is equipped with an expander which is driven by an off-gas exhausted from an oxidant eject path, and which transmits motive power to a compressor, a bypass route in the oxidant eject path which bypasses a humidifier, a flow control valve which changes an opening degree of the bypass route, a voltage sensor which detects an output voltage of the fuel cell stack, a current sensor which detects an output current of the fuel cell stack, and a bypass controlling member which changes a bypass ratio which is a ratio of a magnitude of a flow rate of the off-gas circulating the bypass route with respect to an overall flow rate of the off-gas ejected from the fuel cell stack to the oxidant eject path by the flow control valve according to the output power of the fuel cell stack.

### TECHNICAL FIELD

The present invention relates to a fuel cell system equipped with an expander which recovers energy from an exhaust from a fuel cell.

### BACKGROUND ART

Heretofore, in a fuel cell system, there has been adopted a structure in which a humidifier is equipped between an oxidant supply path and an oxidant eject path of a fuel cell, which humidifies air (an oxidant gas) to be supplied from the oxidant supply path to the fuel cell, using moisture in an off-gas ejected from the fuel cell to the oxidant eject path (for example, refer to Japanese Patent Laid-Open No. 2005-158354).

### SUMMARY OF THE INVENTION

### Problems to be Solved by the Invention

In the fuel cell system disclosed in the above-identified Japanese Patent Laid-Open No. 2005-158354, a bypass route for bypassing a humidifier and a flow control valve for adjusting an opening degree of the bypass route are equipped to the oxidant supply path side or the oxidant eject path side, and by changing the flow rate of gas circulating to the bypass route side, the extent of humidifying of the air supplied from the oxidant supply path to the fuel cell is controlled according to the electricity generated by the fuel cell.

On the other hand, in the fuel cell system, there has been proposed a configuration of providing an expander concentric with a compressor on the oxidant supply path side that is driven by the off-gas ejected from the fuel cell to the oxidant eject path. In the fuel cell system equipped with the humidifier disclosed in Japanese Patent Laid-Open No. 2005-158354, it is conceivable to effectively utilize the energy of the off-gas by providing the expander.

Therefore, the present invention aims at providing a fuel cell system which is capable of balancing humidifying by a humidifier with an off-gas and energy recovery by an expander from the off-gas, and performing the same effectively.

### Means for Solving the Problems

The present invention has been made in order to achieve the above-mentioned object, and relates to an improvement of a fuel cell system, comprising: a fuel cell; an oxidant supply path which is connected to cathode electrodes of the fuel cell and which supplies an oxidant gas to the cathode electrodes; an oxidant eject path which is connected to the cathode electrodes of the fuel cell and to which an off-gas is ejected from the cathode electrodes; a humidifier which is connected to mid-flow of the oxidant supply path and the oxidant eject path while bridging the two, and which humidifies the oxidant gas with moisture in the off-gas; and a compressor which delivers the oxidant gas to the oxidant supply path.

And the fuel cell system is characterized by comprising: an expander which is driven by the off-gas exhausted from the oxidant eject path and which transmits motive power to the compressor; a bypass route in the oxidant eject path which bypasses the humidifier; a bypass ratio changing member which changes a bypass ratio which is a ratio of a magnitude of a flow rate of the off-gas circulating the bypass route with respect to a flow rate of the off-gas ejected from the cathode electrodes to the oxidant eject path; a fuel cell output parameter detecting member which detects a fuel cell output parameter which changes according to the output of the fuel cell; and a bypass controlling member which changes the bypass ratio with the bypass ratio changing member, according to the detected value of the fuel cell output parameter (a first aspect of the invention).

According to the first aspect of the invention, it becomes possible to operate the fuel cell system, while effectively balancing the degree of humidification of the oxidant gas by the humidifier, and the recovered amount of energy from the off-gas by the expander, by changing the bypass ratio according to the output of the fuel cell indicated by the detected value of the fuel cell output parameter.

In the first aspect of the invention, the bypass controlling member is characterized by setting the bypass ratio to a constant value exceeding zero with the bypass ratio changing member, in the case where a detected value of the fuel cell output parameter shows that the output of the fuel cell is within an output range from a predetermined lower limit level to an upper limit level (a second aspect of the invention).

According to the second aspect of the invention, it becomes possible to easily secure the degree of humidification by the humidifier of the oxidant gas and the energy recovery rate from the off-gas by the expander to a certain level or more, by circulating the off-gas to the bypass route by making the bypass ratio constant when the output of the fuel cell is within the output range.

Further, in the first aspect of the invention, the bypass controlling member is characterized by setting the bypass ratio to become smaller with the bypass ratio changing member as the output of the fuel cell which is recognized by a detected value of the fuel cell output parameter becomes larger, in the case where the detected value of the fuel cell output parameter shows that the output of the fuel cell is within an output range from a predetermined lower limit level to an upper limit level (a third aspect of the invention).

According to the third aspect of the invention, the bypass ratio is decreased with the bypass ratio changing member as the output of the fuel cell increases, when the output of the fuel cell is within the low-medium output range. By doing so, it becomes possible to suppress the decrease of energy recovery amount from the off-gas by the expander, with the increase in the flow rate of the off-gas accompanying the increase in output of the fuel cell, while making the humidification of the oxidant gas by the humidifier to a level according to the electricity generation amount of the fuel cell.

Further, in the second aspect of the invention or the third aspect of the invention, the bypass controlling member is characterized by setting the bypass ratio to a first predetermined value or smaller with the bypass ratio changing member, in the case where the detected value of the fuel cell output parameter shows that the output of the fuel cell is less than the lower limit level (a fourth aspect of the invention).

According to the fourth aspect of the invention, in the case where the output of the fuel cell is equal to or lower than the lower limit level, if the flow rate of the off-gas is small, the energy recovered from the off-gas at the expander becomes small, so that the merit obtained from energy recovery decreases. Therefore, in such case, by making the flow rate of the off-gas in the bypass route minute by setting the bypass ratio to equal to or lower than the first predetermined value, it becomes possible to achieve a balance between the energy recovery by the expander and the humidification of the oxidant gas by the humidifier, at an appropriate balance prioritizing the humidification of the oxidant gas by the humidifier.

Further, in any of the second aspect of the invention to the fourth aspect of the invention, the bypass controlling member is characterized by setting the bypass ratio to a second predetermined value or smaller by the bypass ratio changing member, in the case where the detected value of the fuel cell output parameter shows that the output of the fuel cell exceeds the upper limit level (a fifth aspect of the invention).

According to the fifth aspect of the invention, in the case where the output of the fuel cell is equal to or larger than the upper limit level, if the flow rate of the off-gas is large, it is possible to recover sufficient energy at the expander even from the off-gas circulating the humidifier. Therefore, in such case, it becomes possible to achieve a balance between the energy recovery by the expander and the humidification of the oxidant gas by the humidifier, at an appropriate balance prioritizing the humidification of the oxidant gas by the humidifier, by making the flow rate of the off-gas in the bypass route minute by setting the bypass ratio to equal to or lower than the second predetermined value.

### BRIEF DESCRIPTION OF THE DRAWINGS

FIG. 1 is a view showing a configuration of a fuel cell system of the present invention;

FIG. 2 is a flow chart of a process for setting a bypass ratio according to an output of the fuel cell; and

FIG. 3 is an explanatory view for improving energy recovery rate by supplying an off-gas to an expander while bypassing a humidifier.

### MODE FOR CARRYING OUT THE INVENTION

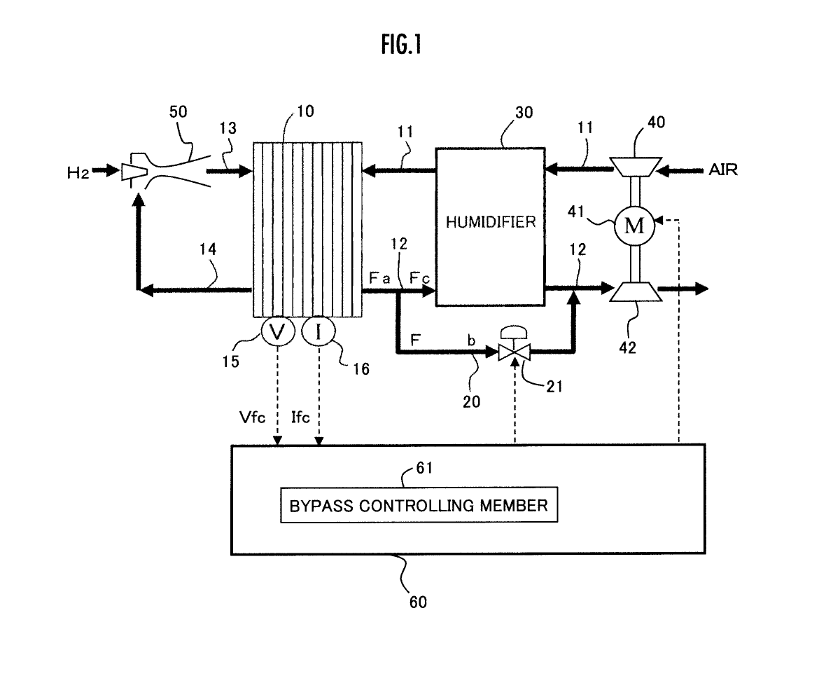

An example of an embodiment of the present invention will be explained with reference to FIGS. 1 through 3. With reference to FIG. 1, a fuel cell system of the present embodiment is mounted, for example, in a fuel cell automobile, and is equipped with a stack of fuel cells 10, an oxidant supply path 11 which is connected to cathode electrodes (air electrodes) of the fuel cell stack 10 and which supplies air (oxidant gas) thereto, an oxidant eject path 12 which is connected to the cathode electrodes of the fuel cell stack 10 and which is ejected with an off-gas after reaction, a fuel supply path 13 which is connected to anode electrodes of the fuel cell stack 10 and which supplies hydrogen (fuel gas) thereto, an ejector 50 which delivers hydrogen from a hydrogen gas tank (not shown) to the fuel supply path 13, and a fuel gas eject path 14 which is connected to the anode electrodes of the fuel cell stack 10 and which returns residual hydrogen to the fuel supply path 13.

Further, the fuel cell system is equipped with a motor 41 which drives a compressor 40 for delivering air to the oxidant supply path 11, an expander 42 which is connected to the motor 41 coaxially with the compressor 40 and which has a turbine (not shown) that rotates by the off-gas circulating in the oxidant eject path 12, a humidifier 30 which is connected to mid-flow of the oxidant supply path 11 and the oxidant eject path 12 while bridging the two, a bypass route 20 which connects the oxidant eject path 12 at an upstream and a downstream side of the humidifier 30 while bypassing the humidifier 30, a flow control valve 21 which changes an opening degree of the bypass route 20 (corresponds to a bypass ratio changing member of the present invention), a voltage sensor 15 which detects an output voltage of the fuel cell stack 10, and a current sensor 16 which detects the output current of the fuel cell stack 10.

The humidifier 30 is equipped with a structure of, for example, transferring only moisture from a fluid in a hollow fiber membrane or a flat membrane and the like, and humidifies the air circulating in the oxidant supply path 11 using the moisture in the off-gas circulating in the oxidant eject path 12. The turbine of the expander 42 is rotated by the off-gas circulating in the oxidant eject path 12, and recovers energy of the off-gas by transmitting the driving force to the compressor 40 via a drive shaft of the motor 41.

Further, the fuel cell system is equipped with a controller 60 which controls an overall operation of the fuel cell system, and voltage detection signals of the voltage sensor 15 and current detection signals of the current sensor 16 are input to the controller 60. Moreover, the operation of the flow control valve 21 and the motor 41 are controlled by control signals output from the controller 60.

The controller 60 is an electronic unit configured from a CPU, a memory and the like, and performs the function of controlling the operation of the fuel cell system by making the CPU execute a control program for the fuel cell system which is stored in the memory.

Further, the controller 60 functions as a bypass controlling member 61 which is a part of the function of controlling the operation of the fuel cell system. The bypass controlling member 61 controls a bypass ratio BR, which is a ratio of a magnitude of a flow rate Fb of the off-gas circulating to the bypass route side 20 with respect to a total flow rate Fa of the off-gas ejected from the cathode electrodes of the fuel cell stack 10 to the oxidant eject path 12 (BR=Fb/Fa), according to the output of the fuel cell stack 10.

When the bypass ratio BR is made larger and a flow rate Fc of the off-gas circulating to the humidifier 30 side is decreased, energy loss of the off-gas by the humidifier 30 (heat release, pressure loss) decreases, so that the energy recovery amount from the off-gas at the expander 42 may be increased. However, the humidifying amount by the humidifier 30 decreases.

On the other hand, when the bypass ratio BR is made smaller and the flow rate of the off-gas circulating to the humidifier 30 side is increased, the humidifying amount of air by the humidifier 30 increases. However, the energy loss of the off-gas by the humidifier 30 increases, so that the energy recovery amount from the off-gas at the expander 42 decreases.

Further, in order to satisfactorily generate power at the fuel cell stack 10, it becomes necessary to humidify air according to the output of the fuel cell stack 10, in order to increase a conductive property of a solid electrolyte membrane of the fuel cell stack 10. If the humidification becomes excessive, there is a fear that the output of the fuel cell stack 10 decreases, because the supply of air is blocked by the water residing in the oxidant supply path 11.

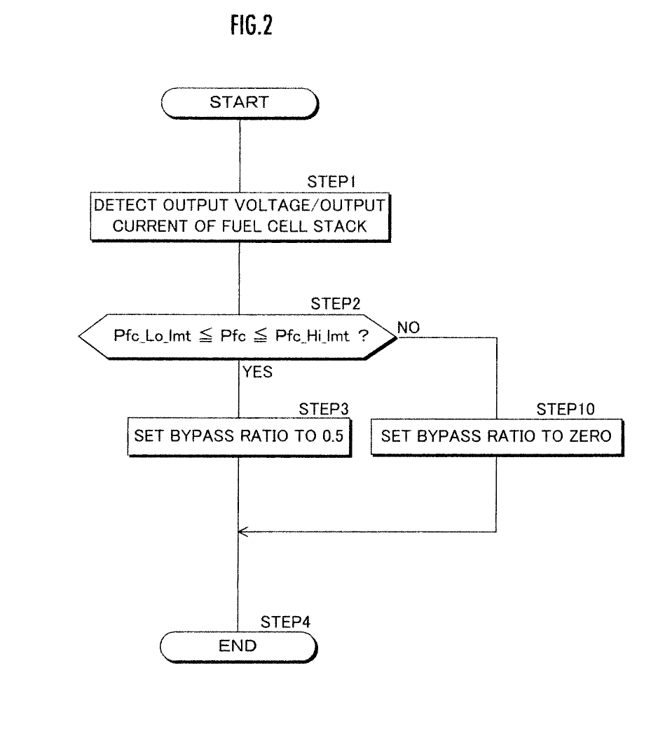

Therefore, the bypass controlling member 61 performs a process of effectively achieving a balance between a degree of humidification of the air by the humidifier 30 and the recovery amount of the energy from the off-gas by the expander 42, by controlling the bypass ratio BR by the flow control valve 21, while taking equibrium between the two into consideration, according to the output of the fuel cell stack 10. Hereinafter, the process will be explained in line with the flow chart shown in FIG. 2.

When the fuel cell stack 10 is performing power-generating operation, the bypass controlling member 61 repeatedly executes the flow chart shown in FIG. 2 and sets the bypass ratio BR. In STEP1, the bypass controlling member 61 detects an output voltage Vfc and an output current Ifc of the fuel cell stack 10 from the voltage detection signal of the voltage sensor 15 and the current detection signal of the current sensor 16.

Subsequently, in STEP2, the bypass controlling member 61 determines whether or not the output power Pfc of the fuel cell stack 10 (Pfc=Vfc*Ifc) is within an output range from a lower limit level Pfc_Lo_lmt to an upper limit level Pfc_Hi_lmt (Pfc_Lo_lmt≦Pfc≦Pfc_Hi_lmt).

The output power Pfc of the fuel cell stack 10 corresponds to a fuel cell output parameter of the present invention. Further, the structure of detecting the output voltage Vfc of the fuel cell stack 10 by the voltage sensor 15 and detecting the output current Ifc of the fuel cell stack 10 by the current sensor 16, in order to detect the output power Pfc of the fuel cell stack 10 corresponds to a fuel cell output parameter detecting member of the present invention.

In STEP2, in the case where the output power Pfc of the fuel cell stack 10 is within the output range from the lower limit level Pfc_Lo_lmt to the upper limit level Pfc_Hi_lmt, the process proceeds to STEP3, and the bypass controlling member 61 controls the flow control valve 21 to an opening degree in which the bypass ratio BR becomes 0.5. Thereafter, the process proceeds to STEP4.

On the other hand, in the case where the output power Pfc of the fuel cell stack 10 deviates from the output range from the lower limit level Pfc_Lo_lmt to the upper limit level Pfc_Hi_lmt, the process branches to STEP10, and the bypass controlling member 61 closes the flow control valve 21 so as to make the bypass ratio BR zero (corresponds to the first predetermined value and the second predetermined value of the present invention). By doing so, the flow rate of the off-gas circulating the bypass route 20 becomes zero. Thereafter, the process proceeds to STEP4.

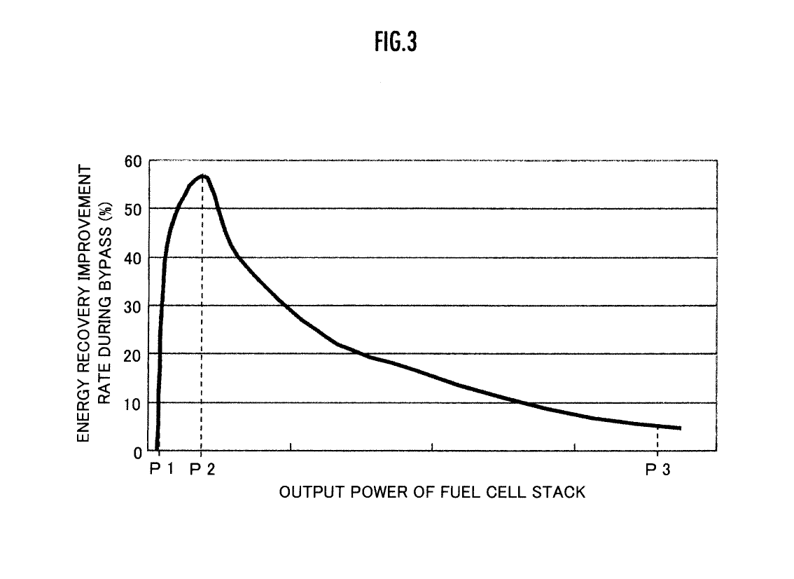

FIG. 3 is a graph showing an improvement rate of the energy recovery amount from the off-gas at the expander 42 when the bypass ratio BR is changed from 0 to 0.5, taking the improvement rate of the energy recovery amount as the axis of ordinate and the output power of the fuel cell stack 10 as the axis of abscissa.

As is apparent from FIG. 3, the improvement rate of the energy recovery amount increases rapidly after the output power of the fuel cell stack 10 exceeds P1. The reason for this is supposed that when the output power Pfc of the fuel cell stack 10 is in the range equal to or less than P1, the flow rate of off-gas itself is small, so that the amount of energy supplied to the expander 42 does not increase as much even when a part of the off-gas is circulated to the bypass route 20 side.

Further, when the output power Pfc of the fuel cell stack 10 exceeds P2, the energy recovery amount gradually decreases. The reason for this is supposed that when the flow rate of the off-gas increases accompanying the increase of the output power Pfc, the energy of the off-gas supplied to the expander 42 via the humidifier 30 is maintained high even when there is some energy loss at the humidifier 30, so that the amount of energy supplied to the expander 42 does not increase as much even when a part of the off-gas is circulated to the bypass route 20 side.

Therefore, by setting the bypass ratio to zero in the case where the output power Pfc of the fuel cell stack 10 is less than the lower limit level Pfc_Lo_lmt which corresponds to P1 in FIG. 3, and when it exceeds the upper limit level Pfc_Hi_lmt which corresponds to P3 in FIG. 3, it becomes possible to effectively perform recovery of energy from the off-gas by the expander 42 while giving priority to humidifying by the humidifier 30, and to achieve a balance between the humidification and energy recovery.

In the present embodiment, the bypass ratio is set to 0.5 at STEP3 in the flow chart of FIG. 2. However, the bypass ratio to be set is not limited to 0.5, and an appropriate value may be determined by experiment, computer simulation or the like.

Further, the bypass ratio is set to a fixed value (0.5) at STEP3 in the flow chart of FIG. 2. However, the bypass ratio may be decreased according to increase of the output power Pfc of the fuel cell stack 10. Decreasing of the bypass ratio in this case may be decreased linearly or stepwise.

Further, the bypass ratio is set to zero at STEP2 in FIG. 2, in the case where the output power Pfc of the fuel cell stack 10 is smaller than the lower limit level Pfc_Lo_lmt, and in the case where the output power Pfc of the fuel cell stack 10 exceeds the upper limit level Pfc_Hi_lmt. However, the by pass ratio may be set to zero in either one of the cases.

Further, the bypass ratio is set to zero at STEP10 in FIG. 2, in both of the case where the output power Pfc of the fuel cell stack 10 is smaller than the lower limit level Pfc_Lo_lmt (corresponds to the first predetermined value of the present invention), and, in the case where the output power Pfc of the fuel cell stack 10 exceeds the upper limit level Pfc_Hi_lmt (corresponds to the second predetermined value of the present invention). However, the bypass ratio may be set to a value other than zero, and the flow rate of the off-gas circulating in the bypass route 20 may be set to a minute amount. Further, in this case, the bypass ratio may be set to a different value when the output power Pfc of the fuel cell stack 10 is smaller than the lower limit level Pfc_Lo_lmt and when the output power Pfc of the fuel cell stack 10 exceeds the upper limit level Pfc_Hi_lmt.

Further, in the present embodiment, the output power of the fuel cell is used as the fuel cell output parameter of the present invention. However, an output current of the fuel cell, a temperature of the fuel cell, a flow rate of the fuel gas supplied to the fuel cell, and the like, may be used as the fuel cell output parameter.

What is claimed is:

1. A fuel cell system, comprising:
a fuel cell stack;
an oxidant supply path which is connected to cathode electrodes of the fuel cell stack and which supplies an oxidant gas to the cathode electrodes;
an oxidant eject path which is connected to the cathode electrodes of the fuel cell stack and to which an off-gas is ejected from the cathode electrodes;
a humidifier which is connected to mid-flow of the oxidant supply path and the oxidant eject path while bridging the two, and which humidifies the oxidant gas with moisture in the off-gas; and
a compressor which delivers the oxidant gas to the oxidant supply path;
the fuel cell system further comprising:
an expander which is driven by the off-gas exhausted from the oxidant eject path and which transmits motive power to the compressor;
a bypass route in the oxidant eject path which bypasses the humidifier;
a bypass ratio changing member which changes a bypass ratio which is a ratio of a magnitude of a flow rate of the off-gas circulating the bypass route with respect to a flow rate of the off-gas ejected from the cathode electrodes to the oxidant eject path;
a fuel cell output parameter detecting member which detects a fuel cell output parameter which changes according to the output of the fuel cell stack; and
a bypass controlling member which changes the bypass ratio with the bypass ratio changing member, according to the detected value of the fuel cell output parameter.

2. The fuel cell system according to claim 1,
wherein the bypass controlling member sets the bypass ratio to a constant value exceeding zero with the bypass ratio changing member, in the case where a detected value of the fuel cell output parameter shows that the output of the fuel cell stack is within an output range from a predetermined lower limit level to an upper limit level.

3. The fuel cell system according to claim 2,
wherein the bypass controlling member sets the bypass ratio to a first predetermined value or smaller with the bypass ratio changing member, in the case where the detected value of the fuel cell output parameter shows that the output of the fuel cell stack is less than the lower limit level.

4. The fuel cell system according to claim 3,
wherein the bypass controlling member sets the bypass ratio to a second predetermined value or smaller by the bypass ratio changing member, in the case where the detected value of the fuel cell output parameter shows that the output of the fuel cell stack exceeds the upper limit level.

5. The fuel cell system according to claim 2,
wherein the bypass controlling member sets the bypass ratio to a second predetermined value or smaller by the bypass ratio changing member, in the case where the detected value of the fuel cell output parameter shows that the output of the fuel cell stack exceeds the upper limit level.

6. The fuel cell system according to claim 1,
wherein the bypass controlling member sets the bypass ratio to become smaller with the bypass ratio changing member as the output of the fuel cell stack which is recognized by a detected value of the fuel cell output parameter becomes larger, in the case where the detected value of the fuel cell output parameter shows that the output of the fuel cell stack is within an output range from a predetermined lower limit level to an upper limit level.

7. The fuel cell system according to claim 6,
wherein the bypass controlling member sets the bypass ratio to a first predetermined value or smaller with the bypass ratio changing member, in the case where the detected value of the fuel cell output parameter shows that the output of the fuel cell stack is less than the lower limit level.

8. The fuel cell system according to claim 7,
wherein the bypass controlling member sets the bypass ratio to a second predetermined value or smaller by the bypass ratio changing member, in the case where the detected value of the fuel cell output parameter shows that the output of the fuel cell stack exceeds the upper limit level.

9. The fuel cell system according to claim 6,
wherein the bypass controlling member sets the bypass ratio to a second predetermined value or smaller by the bypass ratio changing member, in the case where the detected value of the fuel cell output parameter shows that the output of the fuel cell stack exceeds the upper limit level.
